(19) United States
(12) Patent Application Publication
(10) Pub. No.: US 2021/0140796 A1
(43) Pub. Date: May 13, 2021

(54) AUTOMATIC DATA ACQUISITION SYSTEM BASED ON LOW-INSULATION VIBRATING WIRE SENSOR

(71) Applicant: China Institute of Water Resources and Hydropower Research, Beijing (CN)

(72) Inventors: Yunhui Jiang, Beijing (CN); Geping Zhang, Beijing (CN); Tiejun Cui, Beijing (CN); Ding Nie, Beijing (CN); Xiangyang Ju, Beijing (CN); Dongxiang Ma, Beijing (CN); Yujie Shang, Beijing (CN)

(21) Appl. No.: 16/949,541

(22) Filed: Nov. 3, 2020

(30) Foreign Application Priority Data
Nov. 8, 2019 (CN) 201911087233.9

(51) Int. Cl. G01D 5/02

(52) U.S. Cl. CPC G01D 5/02; G01K 7/22

(57) ABSTRACT

An automatic data acquisition system based on a low-insulation vibrating wire sensor is provided, including a power module and a data acquisition module, where the power module includes a storage battery, an external power supply, and a power management unit; the storage battery is connected to the data acquisition module; the power management unit is configured to: according to a working status of the system, selectively control a connection between the data acquisition module and the external power supply and control charging and discharging of the storage battery; the data acquisition module includes a channel switching circuit and a plurality of data acquisition channels, and each data acquisition channel corresponds to at least one vibrating wire sensor; and the channel switching circuit is configured to conduct time-division control on a connected status of the data acquisition channel, to obtain data acquired by the corresponding vibrating wire sensor.

### CROSS-REFERENCE TO RELATED APPLICATIONS

This application claims the benefit of Chinese application number 201911087233.9 filed on Nov. 8, 2019, which is incorporated herein by reference in its entirety and for all purposes.

### TECHNICAL FIELD

The disclosure relates to a data acquisition system, and in particular, to an automatic data acquisition system based on a low-insulation vibrating wire sensor.

### BACKGROUND OF THE INVENTION

In a water conservancy project, a safety monitoring instrument is usually measured in two measurement manners. One manner is manual measurement, which is suitable for measurement during construction of the water conservancy project due to its flexibility and a relatively small limitation from a construction site condition. The other manner is automatic measurement, which is suitable for measurement in an operating period of the water conservancy project because it has high work efficiency but is limited by conditions such as power supply and communication.

However, in actual work, a vibrating wire sensor is usually used for measurement. When the vibrating wire sensor is in a “sub-health” state with a low insulation value, a deviation of automatically measured data is relatively large, and a measured value is unreliable. In addition, as time goes on, the quality of the vibrating wire sensor, the cable jointing quality, connecting a cable core to an automatic acquisition device, etc. cause a decrease in an insulation, thereby affecting an automatic acquisition result and frequently causing an acquisition error or failure.

### SUMMARY OF THE INVENTION

To resolve the above-mentioned problem in the prior art, that is, to solve a problem of how to improve the accuracy and stability of automatically measuring a safety monitoring instrument by using a vibrating wire sensor, the disclosure provides an automatic data acquisition system based on a low-insulation vibrating wire sensor. The system includes a power module and a data acquisition module, where the power module includes a storage battery, an external power supply, and a power management unit; the storage battery is connected to the data acquisition module;

the power management unit is configured to: according to a working status of the system, selectively control a connection between the data acquisition module and the external power supply and control charging and discharging of the storage battery;

the data acquisition module includes a channel switching circuit and a plurality of data acquisition channels, and each data acquisition channel corresponds to at least one vibrating wire sensor; and the channel switching circuit is configured to conduct time-division control on a connected status of the data acquisition channel, to obtain data acquired by the corresponding vibrating wire sensor.

In some embodiments, the power management unit is further configured to:

when the system conducts data acquisition, enable the data acquisition module to be disconnected from the external power supply, and enable the storage battery to be discharged; and

when the system is in a standby state, enable the data acquisition module to be connected to the external power supply, and enable the storage battery to be charged.

In some embodiments, the power module further includes a double-pole double-throw relay, one end of the double-pole double-throw relay is connected to the external power supply, and the other end thereof is connected to the data acquisition module; and the power management unit drives the double-pole double-throw relay to enable the data acquisition module to be connected to or disconnected from the external power supply.

In some embodiments, the vibrating wire sensor includes a vibrating steel wire, a thermistor, and a metal shell, and the vibrating steel wire and the thermistor are located inside the metal shell.

In some embodiments, the data acquisition channel is provided with four connecting terminals that are correspondingly connected to two ends of the vibrating steel wire and two ends of the thermistor, respectively.

In some embodiments, an isolation relay is disposed between the connecting terminals.

In some embodiments, the data acquisition channel is connected to the vibrating wire sensor through a cable; and the cable includes a protection sleeve, a shielding layer, and four cable cores, the shielding layer is connected to a metal shell of the vibrating string sensor, and the four cable cores are correspondingly connected to the two ends of the vibrating steel wire and the two ends of the thermistor, respectively.

In some embodiments, the system further includes a communications module, where the communications module is configured to: when the system conducts data acquisition, disable data communication between the system and the outside; and when the system is in a standby state, enable the system to conduct data communication with the outside.

In some embodiments, the communications module includes a double-pole double-throw relay, and controls an on-off state of the double-pole double-throw relay to enable or disable the communications module.

In some embodiments, each data acquisition channel corresponds to one vibrating wire sensor.

Advantages of the disclosure are as follows:

According to the automatic data acquisition system based on the low-insulation vibrating wire sensor provided in the disclosure, during data acquisition, a storage battery is used for power supply to prevent the frequency interference of a power supply on the vibrating wire sensor and improve the measurement accuracy and stability. Moreover, time-division measurement is conducted between channels and the channels are completely isolated from each other, to more accurately read information from the vibrating wire sensor, thereby further improving the measurement accuracy and stability.

### BRIEF DESCRIPTION OF DRAWINGS

The present invention will hereinafter be described in conjunction with the appended drawing figures, wherein like reference numerals denote like elements, and:

FIG. 1 is a schematic diagram of a main structure of an automatic data acquisition system based on a low-insulation vibrating wire sensor according to the disclosure;

FIG. 2 is a schematic circuit principle diagram of a power module according to the disclosure;

FIG. 3 is a structural block diagram of a conventional vibrating wire sensor;

FIG. 4 is a schematic structural diagram of a vibrating wire sensor according to the disclosure;

FIG. 5 shows a main structure of a cable according to the disclosure;

FIG. 6 is a schematic principle diagram of a channel relay connected between a positive frequency signal and a negative frequency signal according to the disclosure;

FIG. 7 is a schematic principle diagram of a channel relay connected between a positive temperature signal and a negative temperature signal according to the disclosure;

FIG. 8 is a schematic diagram of a double-pole double-throw relay of a communications module according to the disclosure; and

FIG. 9 is a schematic diagram of a main structure of an automatic data acquisition system based on a low-insulation vibrating wire sensor according to another embodiment of the disclosure.

### DETAILED DESCRIPTION

Preferred implementations of the disclosure are described below with reference to accompanying drawings. A person skilled in the art should understand that the implementations herein are merely intended to explain the technical principles of the disclosure, rather than to limit the protection scope of the disclosure.

In actual work, a deviation of automatically measured data is larger than that of manually measured data. One of main reasons is that a principle of manual measurement is different from that of automatic measurement. Consequently, a monitoring sensor in a “sub-health” state can work normally during manual measurement, but obtains an unreliable measured value during automatic measurement. The principles of the manual measurement and the automatic measurement differ in the following aspects.

The manual measurement is carried out by measurement personnel by carrying a portable measurement reading instrument provided with a storage battery; while an automatic acquisition device usually conducts measurement by converting an alternating current into a direct current through an adapter. The quality of the adapter is relatively poor, and an insulation of a sensor is not high, thereby causing an adverse effect on a measurement result, especially a measurement result of a frequency sensor.

During the manual measurement, the measurement personnel use the portable measurement reading instrument to clamp a monitoring sensor for measurement. During the measurement, the portable measurement reading instrument is insulated from the ground; while a conventional automatic acquisition device belongs to electrical equipment, and has to be permanently grounded and is not insulated from the ground.

During the manual measurement, the measurement personnel use the portable measurement reading instrument to conduct measurement on monitoring sensors one by one. After one sensor is measured, a measuring clamp is removed to clamp another sensor for measurement, and only one sensor is measured at a time. During the measurement, there is no mutual interference between sensors. In contrast, cable cores of a plurality of sensors have been connected to channel terminals of the conventional automatic acquisition device in a required corresponding sequence. Only channel jump is conducted during the measurement, and a core of a sensor that is not in a measurement state is not removed from the acquisition device. As a result, a plurality of low-insulation sensors in a “sub-health” state directly affect each other if there are the low-insulation sensors.

Through the above analysis, precisely because of the difference between the two measurement manners, a measured value of a sensor with a relatively low insulation may be inaccurate when the automatic acquisition device is used. Especially some sensors that use a resistance variation for physical quantity conversion, such as temperature sensors, are more largely affected than other sensors.

Similarly, if sensors are all intact and “healthy”, all measurement results should be accurate, and the difference between the two measurement manners will not largely affect the measurement results.

However, in actual engineering, as time goes on, the quality of a sensor, the cable jointing quality, connecting a cable core to an automatic acquisition device, etc. cause a decrease in an insulation of a whole line, and this insulation will affect an automatic acquisition result. Moreover, due to a complex site environment and limitations from materials, construction, and environmental influence, open circuit, disconnection, flooding, and other phenomena frequently occur to a sensor circuit. Consequently, the sensor cannot work normally. For example, a shielding line is a line connecting a sensor shell to a measurement module, and is used to balance a zero potential between an instrument and a sensor. After the shielding line is broken or is rusted by flooding and oxidization, the zero potential becomes imbalanced, and measurement data will be distorted due to interference. For another example, when a frequency signal and a temperature signal of a sensor are short-circuited, a measurement error will be caused.

Therefore, based on the above problems, the disclosure proposes an automatic data acquisition system based on a low-insulation vibrating wire sensor, to make the automatic acquisition device simulate a manual measurement and reading environment as far as possible. The automatic data acquisition system based on the low-insulation vibrating wire sensor provided in the disclosure is described below with reference to accompanying drawings.

Referring to FIG. 1, FIG. 1 exemplarily shows a main structure of a data acquisition system based on a low-insulation vibrating wire sensor. As shown in FIG. 1, the data acquisition system based on the low-insulation vibrating wire sensor provided in this embodiment may include a power module 1, a data acquisition module 2, and a communications module 3.

The power module 1 includes a storage battery 11, an external power supply 12, and a power management unit 13. The storage battery 11 is connected to the data acquisition module 2. The power management unit 13 is configured to: according to a working status of the system, selectively control a connection between the data acquisition module 2 and the external power supply 12 and control charging and discharging of the storage battery 11.

Specifically, when the system conducts data acquisition, the data acquisition module 2 is disconnected from the external power supply 12, and the storage battery 11 is discharged; and the storage battery 11 is used for supplying power to the system. When the system is in a standby state, the data acquisition module 2 is connected to the external power supply 12, and the storage battery 11 is charged. In other words, when the system is in a standby state, the external power supply 12 is used for supplying power to the system and charging the storage battery 11. In some embodiments, the power module 1 further includes a double-pole double-throw relay 14, where one end of the double-pole double-throw relay 14 is connected to the external power supply 12, and the other end thereof is connected to the data acquisition module 2; and the power management unit 13 drives the double-pole double-throw relay 14 to enable the data acquisition module 2 to be connected to or disconnected from the external power supply 12.

Referring to FIG. 2, FIG. 2 exemplarily shows a circuit principle diagram of the power module. As shown in FIG. 2, a negative electrode of the storage battery 11 is grounded, and a positive electrode thereof is connected to “V+”. “V+” supplies power to a main circuit. The external power supply 12 may provide municipal power, solar power, wind power, and other energy sources, but no limitation is set thereto. A positive electrode and a negative electrode of the external power supply 12 are respectively connected to two connectors at one end of the double-pole double-throw relay 14. In two connectors at the other end of the double-pole double-throw relay 14, one connector is connected to a charging circuit 15 of the storage battery 11, and the other connector is grounded. One end of the charging circuit 15 is used to control charging management of the storage battery 11, and the other end of the charging circuit 15 is connected to the positive electrode of the storage battery 11. A relay drive of the double-pole double-throw relay 14 is controlled by the power management unit 13, and the power management unit 13 may be integrated into a controller of the main circuit of the system. After the system is powered on, the external power supply 12 charges the storage battery 11 through the normally closed double-pole double-throw relay 14, and output power to “V+” and “GND” for supplying power to the main circuit. During measurement, the “relay drive” enables the double-pole double-throw relay 14 to be opened, and the storage battery 11 separately supplies power to the main circuit of the system.

The data acquisition module 2 includes a channel switching circuit 21 and a plurality of data acquisition channels 22, and each data acquisition channel 22 corresponds to at least one vibrating wire sensor 23. In this embodiment, each data acquisition channel 22 corresponds to one vibrating wire sensor 23. The channel switching circuit 21 is configured to conduct time-division control on a connected status of the data acquisition channel 22, to obtain data acquired by the corresponding vibrating wire sensor 23. The vibrating wire sensor 23 in this embodiment includes a vibrating steel wire 231, a thermistor 232, and a metal shell 233. The vibrating steel wire 231 and the thermistor 232 are located inside the metal shell 233. The data acquisition channel 22 is provided with four connecting terminals that are correspondingly connected to two ends of the vibrating steel wire 231 and two ends of the thermistor 232, respectively. The data acquisition channel 22 is connected to the vibrating wire sensor 23 through a cable 24. The cable 24 includes a protection sleeve 241, a shielding layer 242, and four cable cores 243, the shielding layer 242 is connected to the metal shell 233 of the vibrating string sensor 23, and the four cable cores are correspondingly connected to the two ends of the vibrating steel wire 231 and the two ends of the thermistor 232, respectively.

Referring to FIG. 3, FIG. 3 exemplarily shows a structural block diagram of a conventional vibrating wire sensor. As shown in FIG. 3, two ends of a vibrating steel wire 231 are fastened to a metal shell 233. During measurement, an acquisition board 234 sends an excitation signal, and transmits the excitation signal to a coil 236 through a wire 235. A resonance frequency is generated between the coil 236 and the vibrating steel wire 231, so that after the vibrating steel wire 231 is vibrated, the coil 236 is reversely excited, and the sensor outputs a vibration signal of the vibrating steel wire 231. After the acquisition board 234 obtains the signal, a frequency value of the vibrating steel wire 231 can be calculated by using a conditioning circuit.

Referring to FIG. 4, FIG. 4 exemplarily shows a structure of the vibrating wire sensor according to this embodiment. As shown in FIG. 4, the vibrating wire sensor 23 in this embodiment includes the vibrating steel wire 231, the thermistor 232, and the metal shell 233. The vibrating steel wire 231 and the thermistor 232 are located in the metal shell 233 and don not interfere with each other. The data acquisition channel 22 is connected to the vibrating wire sensor 23 through the cable 24. Referring to FIG. 5, a cable core 1 (red) of the cable is connected to one end of the vibrating steel wire 231, and a cable core 2 (black) of the cable is connected to the other end of the vibrating steel wire 231. A cable core 3 (green) is connected to one end of the thermistor 232, and a cable core 4 (white) is connected to the other end of the thermistor 232. The shielding layer 242 is wrapped around the four cable cores mentioned above and is wrapped by the protection sleeve 241, and is connected to the metal shell 233 of the vibrating wire sensor 23. Signals of the vibrating wire sensor 23 are defined as a positive frequency signal, a negative frequency signal, a positive temperature signal, a negative temperature signal, and a shielded signal, and respectively correspond to code names: F+, F−, T+, T−, and G. Four cores are defined for a connecting terminal of each data acquisition channel, and respectively correspond to signals F+, F−(G), T+, and T−. A relay switch is disposed on each data acquisition channel 22 to control an open/closed state of the channel.

The open/closed state of the data acquisition channel 22 is controlled by a channel relay. An isolation relay may be disposed between connecting terminals. Referring to FIG. 6 and FIG. 7, a channel relay 25 may be connected between a positive frequency signal and a negative frequency signal, and a channel relay 26 may be connected between a positive temperature signal and a negative temperature signal. In other words, a signal 34 (F+) of the sensor is connected to a cable core 1, a signal 35 (F−) of the sensor is connected to a cable core 2, a signal 38 (T+) of the sensor is connected to a cable core 3, and a signal 39 (T−) of the sensor is connected to a cable core 4. An excited/acquired positive frequency signal 30 and an excited/acquired negative frequency signal 32 correspondingly exist at the other two ports of the channel relay 25. An excited/acquired positive resistance signal 36 and an excited/acquired negative resistance signal 37 correspondingly exist at the other two ports of the channel relay 26. In this embodiment, the isolation relay is disposed between the connecting terminals, and then the sensor is connected to the system. In this way, during measurement, only one vibrating wire sensor can be used for measurement at one time by controlling channel jump and the opening/closing of the isolation relay. Moreover, there is no mutual interference between the vibrating wire sensor and other vibrating wire sensors.

The communications module 3 is configured to: when the system conducts data acquisition, disable data communication between the system and the outside; and when the system is in a standby state, enable the system to conduct data communication with the outside. Specifically, the communications module may be provided with a double-pole double-throw relay 31, and the double-pole double-throw relay 31 is electrically connected to the main circuit of the system, and controls an on-off state of the double-pole double-throw relay 31 to enable or disable the communications module 3. Referring to FIG. 8, the communications module conducts RS485 communication. After the main circuit of the system is powered on, an RS485 signal is transmitted through the normally closed double-pole double-throw relay 31. During measurement, a “relay drive” enables the double-pole double-throw relay 31 to be opened, to completely disable communication. At this time, communication between the communications module 3 and the outside is completely disabled, and the main circuit of the system is in a floating state.

A person skilled in the art can understand that physical forms of the power module 1 and the data acquisition module 2 may be independent of each other, or certainly, the power module 1 and the data acquisition module 2 may be a functional unit with some functions integrated into one physical module. For example, the automatic data acquisition system based on the low-insulation vibrating wire sensor includes a controller 4, and the power management unit 13 is integrated into the controller 4.

Referring to FIG. 9, FIG. 9 exemplarily shows a main structure of an automatic data acquisition system based on a low-insulation vibrating wire sensor according to another embodiment. After the system is started, a mains power switch is opened, a main controller 4 starts to run, and a part of power is used to charge a storage battery 11. A switch of each data acquisition channel 22 is closed, and a communication switch of a communications module 3 is closed for data communication. When no measurement is conducted, vibrating wire sensors 23 of all the data acquisition channels 22 are completely isolated from each other and also completely isolated from a main circuit. During measurement, time-division measurement is conducted between all the data acquisition channels 22 and time-division measurement is also conducted between different sensors of all the channels, so as to ensure that only one sensor is in a connected and measured state at a single time.

When the system conducts frequency acquisition, the mains power switch is opened, the system is switched to be separately powered by the storage battery 11, the communications switch is opened, and a frequency signal of a corresponding vibrating wire sensor 23 is connected. Because the frequency signal is connected in a single-ended input manner, a positive frequency signal F+ (red) is an excited transmitted signal, and a negative frequency signal F− (black) is a zero potential reference. A ground signal of the data acquisition module 2 at this time is completely isolated, and F− (black) of the sensor becomes the only reference ground of the whole system after being connected. According to the foregoing manner, signal interference caused by a plurality of grounds or floating can be isolated to the greatest extent.

When the system conducts temperature acquisition, a frequency switch of the vibrating wire sensor 23 is closed, a temperature sensor switch is connected, only T+(white) and T−(green) lines are kept in an online sensor circuit, and all other sensor circuits have no circuit. This manner can avoid a problem of a temperature value error caused by a short circuit of the sensor circuit.

To sum up, according to the automatic data acquisition system based on the low-insulation vibrating wire sensor provided in this embodiment, during data acquisition, the storage battery is used for power supply to prevent the frequency interference of a power supply on the vibrating wire sensor and improve the measurement accuracy and stability. Moreover, time-division measurement is conducted between channels and the channels are completely isolated from each other, to more accurately read information from the vibrating wire sensor, thereby further improving the measurement accuracy and stability.

The foregoing provides the description about the technical solutions of the disclosure with reference to the preferred implementations shown in accompanying drawings. A person skilled in the art should easily understand that the protection scope of the disclosure is apparently not limited to these specific implementations. A person skilled in the art can make equivalent modification or replacements to the relevant technical features without departing from the principles of the disclosure, and the technical solutions obtained after these modification or replacements should fall within the protection scope of the disclosure.

What is claimed is:

1. An automatic data acquisition system based on a low-insulation vibrating wire sensor, comprising a power module and a data acquisition module, wherein the power module comprises a storage battery, an external power supply, and a power management unit; the storage battery is connected to the data acquisition module;
the power management unit is configured to: according to a working status of the system, selectively control a connection between the data acquisition module and the external power supply and control charging and discharging of the storage battery;
the data acquisition module comprises a channel switching circuit and a plurality of data acquisition channels, and each data acquisition channel corresponds to at least one vibrating wire sensor; and the channel switching circuit is configured to conduct time-division control on a connected status of the data acquisition channel, to obtain data acquired by the corresponding vibrating wire sensor.

2. The automatic data acquisition system based on the low-insulation vibrating wire sensor according to claim 1, wherein the power management unit is further configured to:
when the system conducts data acquisition, enable the data acquisition module to be disconnected from the external power supply, and enable the storage battery to be discharged; and
when the system is in a standby state, enable the data acquisition module to be connected to the external power supply, and enable the storage battery to be charged.

3. The automatic data acquisition system based on the low-insulation vibrating wire sensor according to claim 2, wherein the power module further comprises a double-pole double-throw relay, one end of the double-pole double-throw relay is connected to the external power supply, and the other end thereof is connected to the data acquisition module; and the power management unit drives the double-pole double-throw relay to enable the data acquisition module to be connected to or disconnected from the external power supply.

4. The automatic data acquisition system based on the low-insulation vibrating wire sensor according to claim 1, wherein the vibrating wire sensor comprises a vibrating steel wire, a thermistor, and a metal shell, and the vibrating steel wire and the thermistor are located inside the metal shell.

5. The automatic data acquisition system based on the low-insulation vibrating wire sensor according to claim 4, wherein the data acquisition channel is provided with four connecting terminals that are correspondingly connected to two ends of the vibrating steel wire and two ends of the thermistor, respectively.

6. The automatic data acquisition system based on the low-insulation vibrating wire sensor according to claim 5, wherein an isolation relay is disposed between the connecting terminals.

7. The automatic data acquisition system based on the low-insulation vibrating wire sensor according to claim 6, wherein the data acquisition channel is connected to the vibrating wire sensor through a cable; and
the cable comprises a protection sleeve, a shielding layer, and four cable cores, the shielding layer is connected to a metal shell of the vibrating string sensor, and the four cable cores are correspondingly connected to the two ends of the vibrating steel wire and the two ends of the thermistor, respectively.

8. The automatic data acquisition system based on the low-insulation vibrating wire sensor according to claim 1, further comprising a communications module, wherein the communications module is configured to: when the system conducts data acquisition, disable data communication between the system and the outside; and when the system is in a standby state, enable the system to conduct data communication with the outside.

9. The automatic data acquisition system based on the low-insulation vibrating wire sensor according to claim 8, wherein the communications module comprises a double-pole double-throw relay, and controls an on-off state of the double-pole double-throw relay to enable or disable the communications module.

10. The automatic data acquisition system based on the low-insulation vibrating wire sensor according to claim 1, wherein each data acquisition channel corresponds to one vibrating wire sensor.
